(19) United States
(12) Patent Application Publication
(10) Pub. No.: US 2014/0029811 A1
(43) Pub. Date: Jan. 30, 2014

(54) USER-AUTHENTICATING, DIGITAL DATA RECORDING PEN

(71) Applicant: INTERNATIONAL BUSINESS MACHINES CORPORATION, Armonk, NY (US)

(72) Inventors: Wayne M. DELIA, Poughkeepsie, NY (US); Edward E. KELLEY, Wappingers Falls, NY (US); Franco MOTIKA, Hopewell Junction, NY (US)

(73) Assignee: INTERNATIONAL BUSINESS MACHINES CORPORATION, Armonk, NY (US)

(21) Appl. No.: 14/043,022

(22) Filed: Oct. 1, 2013

Related U.S. Application Data
(63) Continuation of application No. 12/331,690, filed on Dec. 10, 2008, now abandoned.

(51) Int. Cl. G06K 9/00

(52) U.S. Cl. CPC G06K 9/00167
USPC 382/119

(57) ABSTRACT

A user-authenticating, digital data recording pen is provided. User-authenticating includes: using the digital data recording pen to write out by a user a handwritten password, which includes a handwritten character string to be authenticated; digitally comparing by the digital data recording pen the handwritten password to at least one handwritten password pre-stored for the user in the digital data recording pen; authenticating by the digital data recording pen the user if the handwritten password is within a defined tolerance of the pre-stored handwritten password; and if authenticated, associating by the digital data recording pen an indication of user authentication with data, such as a writing, of the user produced using the digital data recording pen. In one embodiment, the writing could be any alpha-numerical character string of the user interacting with a system via the digital data recording pen.

### CROSS-REFERENCE TO RELATED APPLICATIONS

This application is a continuation of U.S. application Ser. No. 12/331,690, entitled “USER-AUTHENTICATING, DIGITAL DATA RECORDING PEN”, filed Dec. 10, 2008, which published Jun. 10, 2010, as U.S. Patent Publication No. 2010-0139992 A1, and which is hereby incorporated herein by reference in its entirety.

### BACKGROUND

The present invention relates in general to user-authentication, and more specifically, to a digital data recording pen with an integrated authentication facility providing handwritten password authentication of a user, alone or in combination with a multi-level authentication protocol of the digital data recording pen to a system.

### BACKGROUND OF THE INVENTION

As ever more people conduct business electronically, the need for digital signature authentication increases. For example, when electronically banking, electronically filing taxes, or when entering contracts over the Internet, a digital signature may be collected for authentication by a system.

In one approach, the system may employ a pointing device connected via a USB port to a main computer, wherein motions of the pointing device are tracked (e.g., via a stylus pad) and recorded by the main computer, with the results being applied to a workstation application program such as an optical character recognition program, presentation display/mark-up application, or a low-level “paint” program. The workstation application program determines whether the user employing the pointing device is authenticated to enter the information. To further facilitate electronic business, enhancements to such a digital signature authentication approach are deemed desirable.

### SUMMARY OF THE INVENTION

Provided herein therefore, in one aspect, is a digital pen user-authentication method, which includes: using a digital data recording pen to write out by a user and capture by the digital data recording pen a handwritten password, the handwritten password comprising at least one handwritten character string to be authenticated; determining, by the digital data recording pen, whether to authenticate the user based on the handwritten password, the determining by the digital data recording pen including: digitally comparing, by the digital data recording pen, the form and content of the handwritten password to the form and content of at least one handwritten pre-stored for the user in the digital data recording pen; authenticating, by the digital data recording pen, the user if the handwritten password of the user is within a defined tolerance of the at least one handwritten password pre-stored for the user in the digital data recording pen; and if user-authenticated, associating by the digital data recording pen an indication of user-authentication with data of the user produced using the digital data recording pen.

In another aspect, an apparatus is provided which comprises a digital data recording pen. The digital data recording pen includes an authentication component for digitally authenticating a user's handwritten password. The handwritten password includes at least one handwritten character string to be authenticated. The digital data recording pen responds to the user writing out the handwritten password by: digitally comparing, by the digital data recording pen, the form and content of the handwritten password to the form and content of at least one handwritten password pre-stored for the user in the digital data recording pen; authenticating, by the digital data recording pen, the user if the handwritten password of the user is within a defined tolerance of the at least one handwritten password pre-stored for the user in the digital data recording pen; and if user-authenticated, associating by the digital data recording pen an indication of user-authentication with data of the user produced using the digital data recording pen.

In a further aspect, an article of manufacture is provided which includes at least one computer-readable medium having computer-readable program code logic to facilitate user-authentication by a digital data recording pen. The computer-readable program code logic, when executing on a processing unit within the digital data recording pen performing: recording, by the digital data recording pen, a handwritten password of a user of the digital data recording pen to be authenticated, the handwritten password comprising at least one handwritten character string to be authenticated; digitally comparing, by the digital data recording pen, the form and content of the handwritten password to the form and content of at least one handwritten password pre-stored for the user in the digital data recording pen; authenticating, by the digital data recording pen, the user if the handwritten password of the user is within a defined tolerance of the at least one handwritten password pre-stored for the user in the digital data recording pen; and if user-authenticated, associating by the digital data recording pen an indication of user-authentication with data of the user produced using the digital data recording pen.

Additional features and advantages are realized through the techniques of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one embodiment of a system utilizing a digital data recording pen for user-authentication, in accordance with an aspect of the present invention;

FIG. 2 illustrates one embodiment of certain features of an authentication component provided in a digital data recording pen, in accordance with an aspect of the present invention;

FIGS. 3A & 3B are a flowchart of one embodiment of logic for user-authentication by a digital data recording pen, in accordance with an aspect of the present invention;

FIGS. 4A & 4B are a flowchart of one embodiment of logic for user-authentication by a digital data recording pen to a system, in accordance with an aspect of the present invention;

FIG. 5 is a flowchart of one embodiment of logic for loading one or more handwritten passwords into a digital data recording pen, in accordance with an aspect of the present invention; and

FIG. 6 depicts one embodiment of a computer program product or article of manufacture incorporating one or more aspects of the present invention.

### DETAILED DESCRIPTION OF THE INVENTION

Commercially available digital pens are capable of detecting, recording, storing, and converting handwritten notes to digital alpha-numeric character data. By way of example, ipen4you.com markets one such product as an “i-Pen Presentation Digital Pen/Optical Pen Mouse.”

As described herein, parts of the data thus recorded may comprise a potential secure data transaction or authenticated document tied to the identity of the user or owner of the digital pen. For example, a physician may wish to record a patient's prescription or physical examination notes, or a bank customer may wish to initiate a secured bank transaction. The concepts presented herein enable a user to authenticate the user's identity using a digital data recording pen, such as described herein, by writing out a handwritten password comprising one or more handwritten character strings. The handwritten password to be authenticated is digitally compared to a representative, graphic, handwritten sample stored in the digital data recording pen, with a tolerance level suitable to cover minor acceptable differences. Once a user's identity is validated to the digital data recording pen, the user's data recorded by the digital data recording pen can be used to form one or more secure, authenticated transactions.

Existing digital pens (such as the above-referenced i-Pen) are typically not a stand-alone data recording device, but rather a pointing device connected via a USB port to a main computer. Motions in the digital pen are tracked and recorded, and the results are applied to workstation application program, such as an optical character recognition program, a presentation display mark-up application program, or a low-level “paint” program.

In contrast, provided herein, in one aspect, is a portable, stand-alone digital data recording pen that is capable of independently authenticating one or more users to prepare and transmit a secure data transaction. As used herein “pen” refers to any pen, pencil, device, etc., capable of functioning as a portable, stand-alone digital recording mechanism as described herein. The digital data recording pen disclosed herein has widespread applicability in business, and in the medical profession (wherein doctors could produce handwritten or digital copies of secure, confidential data on patient medical histories, as well as issue authenticated patient medication prescriptions).

In another example, in banking, for a business to transfer money from one bank customer to another via personal check, the transaction is said to be authenticated by the signature of the transferring person, who approves of the removal of money from his account and approves the transfer of money to the other person's account. In a similar manner, a technique is needed to authenticate the user of a digital data recording pen, so that the information recorded by the digital data recording pen can be considered to be as authoritative as the signature on a bank draft.

User-authentication is enabled, in one embodiment, by an initialization routine in which a representative handwritten password (i.e., an alpha-numeric/symbolic phrase, key or signature) is established, and stored as a graphic image in memory within the digital data recording pen. One or more versions of the handwritten password for each user may be stored. When the user of the digital data recording pen initiates an authentication protocol (for example, by actuating an authentication mode via a key, switch, button, etc.), and writes out the handwritten password, it is recorded by the digital data recording pen, and automatically digitally compared to the representative graphic image(s) stored in the pen's memory for the user, allowing for a tolerance designed to accept minor differences in the handwritten passwords or signatures, while still acknowledging authentication of the user. Once authentication has been achieved, data recorded by the user using the digital data recording pen is established as secure and authenticated. Various approaches for digitally comparing handwritten samples are known in the art, and can be employed in the digital comparison of handwritten passwords described herein. For example, Topaz Systems, Inc. markets a signature compare product which allows comparison of two signatures. Further examples of existing signature verification software are SignCheck®, an automatic check verification system marketed by App-Infomatic Davos, of Davos, Switzerland; and SigCheck™ signature comparison software offered by SQN Banking Systems.

In another aspect, the digital data recording pen provides a multi-level (or multi-factor) authentication protocol for, for example, signing documents for a system. Once authenticated, the digital data recording pen allows a user of the pen to sign a document if, for example, the document is stored on a server of a system being interfaced through the digital data recording pen, or when the server processes a transaction as a result of a valid user interfacing with the system server via the digital data recording pen.

In another aspect, the digital data recording pen is a functional pen which can be used, for example, for signing a stylus pad of a system to be accessed via the digital data recording pen, or for example, for signing any document with ink or lead. Size and configuration of the digital data recording pen may vary to accomplish the functions set forth herein. In one embodiment, the digital data recording pen contains a small logic chip, a digital data recording protocol, and a data storage device or memory unit, enabling an authorized user of the pen to be authenticated, and to associate a secure authorization indication to the user when signing a document, for example, in an implementation where a system server is part of the process for recording the transaction.

In one specific, multi-level authentication approach to a system implementation, authentication is first performed by having the digital data recording pen communicate a digital identification to the system server that is recording or processing a transaction for the user. The digital pen authenticates itself to the system server by sending from the pen a digital (user) ID and digital password recognized by the system server. This digital identification and digital password are pre-stored in the digital data recording pen for the user. A next level of authentication then ensures that the digital data recording pen is being used by the actual user, and not by someone who has, for example, stolen the digital pen, user ID and password. Thus, authentication is performed as described above by recording by the pen handwriting motions of the user as the user writes out the handwritten password, comprising at least one handwritten character string to be authenticated. The digital image of the handwritten password is digitally compared (e.g., using an existing digital signature comparison technique) to one or more versions or samples of the password for the user stored, for example, in flash memory of the digital data recording pen. If the handwritten passwords match within a certain defined tolerance, then the user of the pen is authenticated, and information recorded via the digital data recording pen by the user is authoritatively identified with the user of the digital data recording pen. One or more sets of handwritten password samples can be stored on the digital data recording pen for each user of one or more users to facilitate separate identification and authentication of the one or more users.

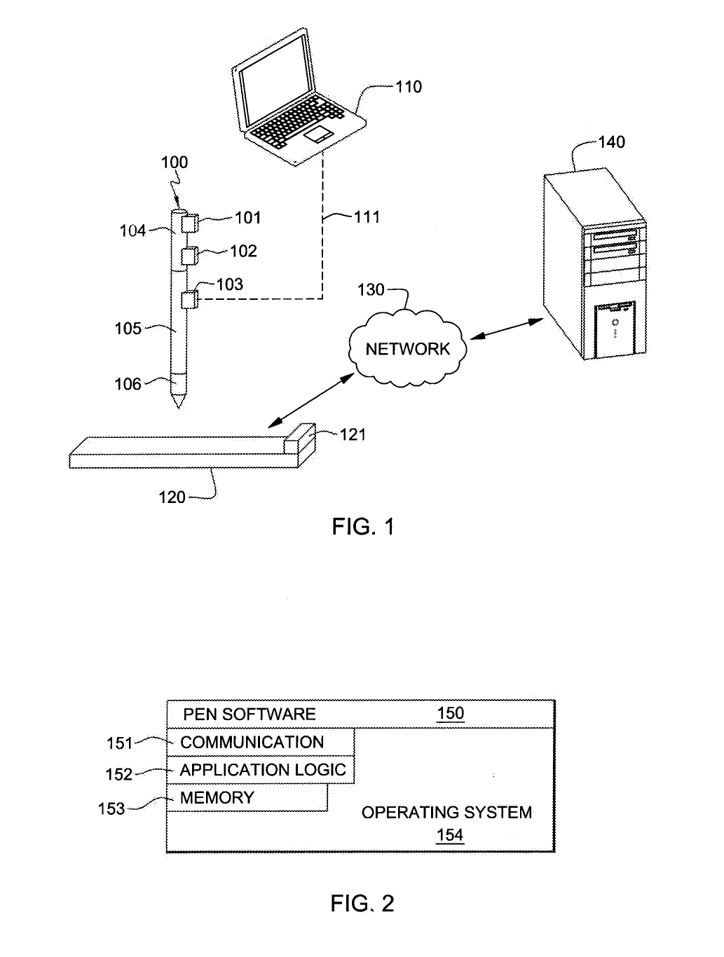

FIGS. 1-6 described below present various versions of a user authenticating, digital data recording pen, in accordance with an aspect of the present invention.

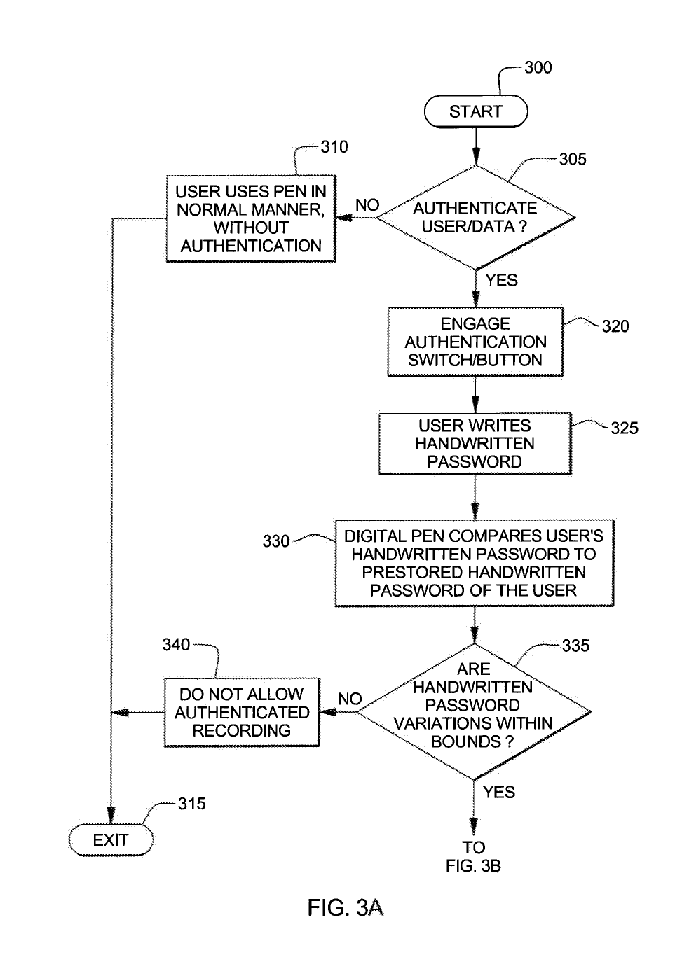

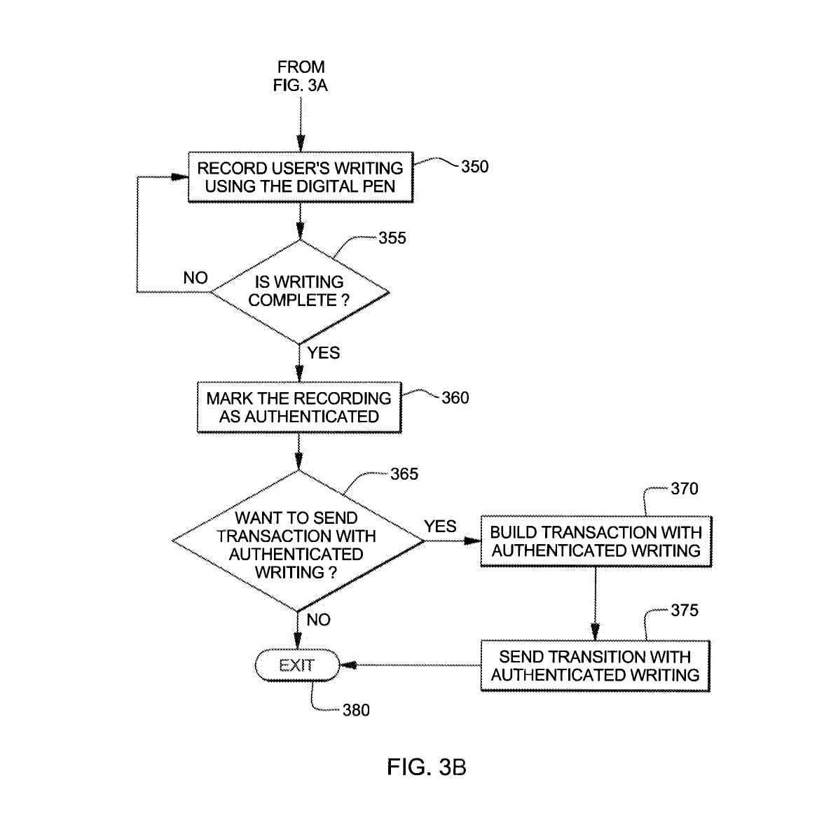

Beginning with FIG. 1, one embodiment of a digital data recording pen 100 is illustrated for use, for example, in interfacing a user to a system comprising a stylus pad 120 (with a signal light 121), a network 130 and a system server 140. In one embodiment, a computer 110 is employed in initially loading (via a USB cable 111 and a USB port 103 in digital data recording pen 100), a respective digital identification and digital password for digital data recording pen 100. Digital data recording pen 100 further includes a transmit digital identification and digital password switch (not shown), a load handwritten password mode switch 101, and an authenticate handwritten password mode switch 102 to be employed as described below in connection with FIGS. 3A-5. Digital data recording pen 100 comprises, in one example, a power supply 104, an authentication component 105 (including a processing unit, memory unit and control logic) and a data recording component 106 (comprising any conventional digital handwriting recordation facility). In the illustrated embodiment, USB connection 111 to digital data recording device 100 is temporary and only employed to initially download the digital identification and digital password for digital data recording device 100. After that, the digital data recording pen (or device) is a portable, stand-alone device which allows for one or more levels of user authentication, for example, for authenticating a user's handwritten data recorded by the digital data recording device, or for authenticating a user of the digital data recording pen to a system.

FIG. 2 illustrates one embodiment of certain authentication logic provided in a digital data recording pen, in accordance with an aspect of the present invention. This logic comprises, in one embodiment, digital data recording pen software 150 loaded within the pen, wireless communication logic 151, application logic 152 and memory 153, along with an operating system 154. The digital pen's operating system 154 enables application logic 152 to record and digitally compare handwritten passwords, and enables the storage of handwritten passwords in memory 153, which may comprises a physical memory unit. Application logic 152 also stores and updates a digital identification and digital password, if desired, in memory 153, using the above-described USB port 103 (see FIG. 1) and computer 110. The sending of the digital identification, digital password and/or a user-authentication indication (such as described herein) is enabled via communication logic 151.

FIGS. 3A & 3B depict one embodiment of a protocol for using a digital data recording pen, in accordance with an aspect of the present invention. The protocol begins 300 with a determination whether the user of the digital data recording pen wishes to be authenticated for the data being recorded 305. In one embodiment, an authentication switch, button, etc., is provided on the digital data recording pen to allow the user to place the digital pen in an authentication mode. If “no”, then the user may use the pen in the normal manner, without authentication of any writing recorded, or data entered using the pen 310. As noted above, in one implementation, actual ink-writing or pencil-writing capability may be provided with the digital data recording device. Alternatively, the digital data recording device could be used as a stylus to enter data or writings into a system, again without an authentication indication being associated therewith. Once use of the digital data recording pen is complete, processing exits the logic flow 315.

Assuming that the user wishes to be authenticated, then the user places the digital data recording pen in authentication mode (e.g., by engaging an authentication switch, button, etc. on the pen) 320. The user then writes out a predetermined handwritten password 325, which is recorded or imaged by the digital data recording pen. As noted, the predetermined handwritten password comprises at least one handwritten character string to be authenticated, such as the signature of the user. Alternatively, the handwritten character string could comprise any alpha-numeric character string predetermined by the user. The digital data recording pen then compares the digital image of the user's handwritten password to be authenticated to one or more pre-stored digital images of the handwritten password 330, and determines whether any variations between the user's handwritten password and the pre-stored handwritten passwords are within acceptable bounds or tolerances 335. If “no”, then recording of data (e.g., any writing) by the user using the digital data recording pen may be blocked, or the digital data recording pen may simply prevent an authentication indication from being associated with data entered by the user 340 using the pen, which completes processing 315.

Assuming that the handwritten password to be authenticated is within acceptable tolerances of the pre-stored handwritten password(s) for the user, then the digital data recording pen records the user's data (e.g., writing) 350 (FIG. 3B), and determines when the data entry is complete 355, either, for example, via a user input mechanism (not shown) provided on the digital data recording device, or, for example, an inactivity counter. Once logic determines that the data entry is complete, an authentication indication is associated with the recorded writing 360, and logic determines whether the user, or pre-configured communication logic, wishes to send the recorded authenticated data (or writing) as a transaction to, for example, a system's server 365. If “yes”, then a transaction is built with the authenticated data 370 and sent, for example, wirelessly, from the digital data recording pen 375, which completes processing 380. If no transaction is to be sent with the authenticated writing, then processing is complete 380. By way of example, an authenticated writing (or data) may be retained in memory within the digital data recording pen and subsequently downloaded, for example, to a system. One example of this might be periodic downloading of authenticated data (e.g., writings) to a central server by a medical professional.

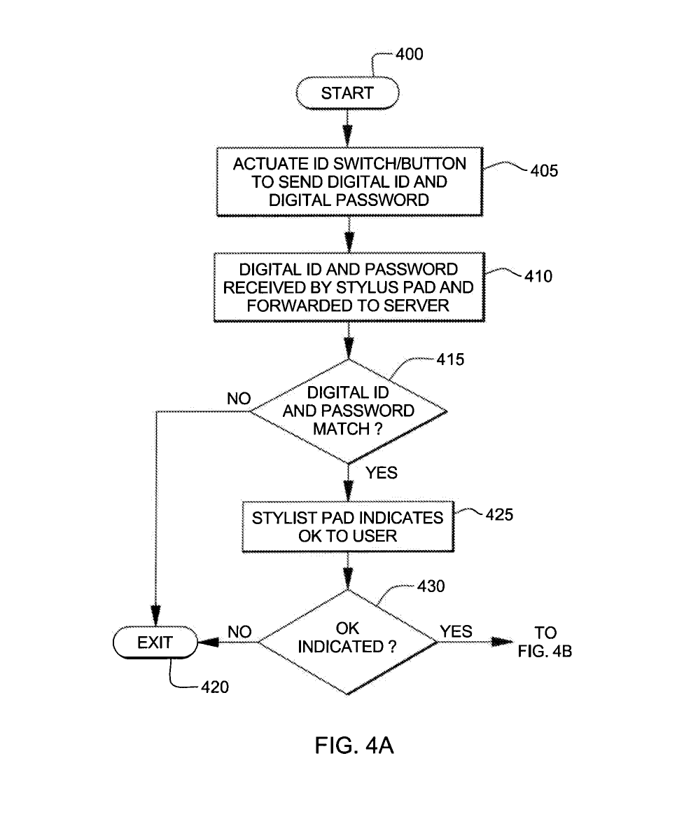

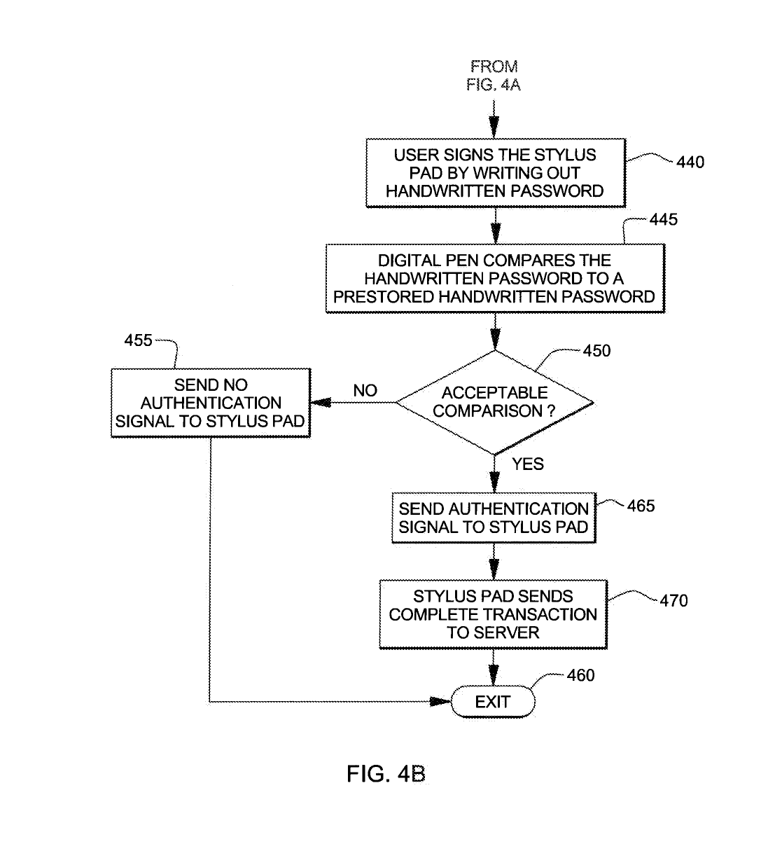

FIGS. 4A & 4B depict one example of logic which may be employed in a secure validation system and process utilizing a digital data recording pen, in accordance with an aspect of the present invention. This approach, in addition to utilizing the digital data recording pen such as described herein, employs a system's server to which the digital data recording pen may interconnect via, for example, a secure wireless network. In this embodiment, the digital data recording pen is a user interface which is capable of self-authentication.

As shown, processing begins 400 with a user actuating an identification mechanism, such as a switch, button, etc., to send a digital identification and digital password from the digital data recording device to the system 405. In one embodiment, a stored digital identification and digital password may be sent from the digital data recording device to a wireless sensor in a system interface device (such as a stylus pad), for example, via radio wave communication such as Bluetooth™. The digital identification and digital password are received by the interface device and forwarded to the system's server 410, which determines whether the digital identification and digital password are valid 415, and if “no”, processing terminates 420. Otherwise, the system server signals the interface device to indicate acceptance of the digital identification and password via, for example, a visual feedback employing, for example, a light 121 (FIG. 1) associated with a stylus pad functioning as the interface device. If validation of the digital identification and password is not provided to the user 430, then processing terminates 420. Otherwise, the user proceeds to write out a handwritten password using the digital data recording device 440 (FIG. 4B), after which the digital data recording pen compares the user's handwritten password to be authenticated to one or more pre-stored versions of the handwritten password 445.

As noted above, each authorized user writes one or more samples of the handwritten password, which are converted to a digital image(s) and stored in the digital data recording pen's memory. Each sample handwritten password (e.g., signature) is captured by the digital data recording pen. Since a person's handwriting of a password may be similar but not exactly the same, logic is provided to analyze and record differences between the handwritten password to be authenticated and the one or more pre-stored versions of the handwritten password. The extremes of the differences may be the bounds for accepting or rejecting a handwritten password as authenticated. Various approaches are known in the art for digitally analyzing and indicating whether a comparison of handwriting matches. As with the example of FIGS. 3A-3B, if a user wishes to be authenticated to the digital data recording pen, the user actuates an authentication switch, button, etc., to alert the digital pen that authentication is to take place. The same or different switch may be engaged to subsequently alert the digital pen that the handwritten password is complete and that it is time to compare the handwritten password to the set of handwritten passwords within the digital data recording pen to determine whether it is within established bounds.

If the comparison is unacceptable, then the digital data recording pen sends no authentication signal to the stylus pad 455, and the authentication protocol terminates 460. However, if the digital pen determines that the comparison is acceptable 450, then an authentication indication is sent to the stylus pad 465 from the digital data recording pen. The stylus pad then sends a complete transaction indication to the system server 470, which completes the processing 460.

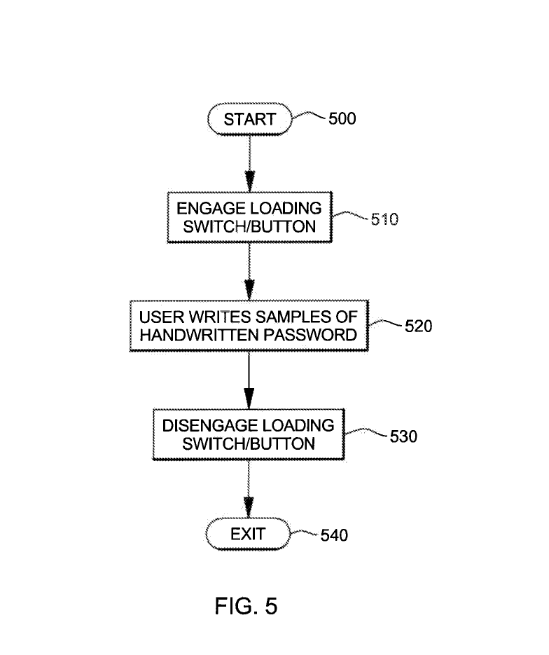

As noted, one or more sets of handwritten passwords (e.g., signatures or other alpha-numeric handwritten character strings) can be stored within the digital data recording pen to enable subsequent authentication of a user (of one or more possible users storing handwritten password samples). FIG. 5 depicts one embodiment of logic for storing a handwritten password in the digital data recording pen. The logic begins 500 with the user actuating a loading switch, button, etc., provided on the digital data recording pen to inform the digital data recording pen that a handwritten password to be provided for storage, that is, that the pen is to enter a handwritten password load mode. The user writes one or more samples of the handwritten password using the digital data recording pen 520, and the digital data recording pen records, for example, digital images of the handwritten password samples. The user then disengages the loading switch, button, etc., 530, which completes the handwritten password upload process 540 for the digital data recording pen.

Those skilled in the art will note from the above discussion that provided herein is a stand-alone self-authenticating digital data recording pen (or device) which may be used either alone to authenticate user-entered data (or writings), or in association with a secure validation system and process, wherein the digital data recording pen is the user interface, capable of self-authentication and capture of documentation and data for transfer to the system server, for example, over a secure wireless network. In the system implementation, the digital data recording pen may: provide an interface to a documents database, store captured data/writings, verify uploaded document integrity and provide user/data validation. In an integrated system approach, in addition to the digital data recording pen, a wireless network and protocol are provided, along with a system or host server and associated logic functions which enable end-to-end interactive, mobile and secure processing allowing for real-time document authentication, validation and processing. Further, a variety of logic applications can be provided on the digital data recording pen to make use of authenticated information recorded by the digital pen, such as printing out a prescription or verifying a bank check.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

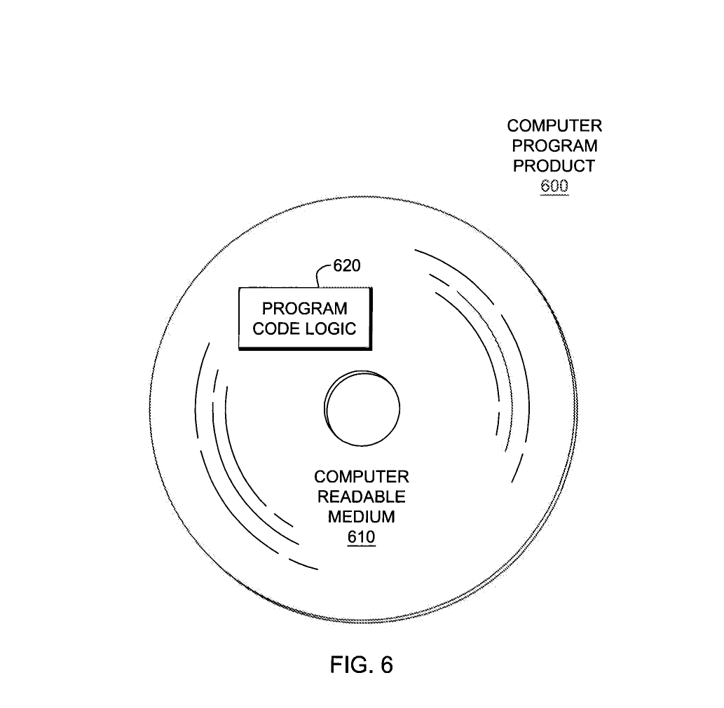

One example of an article of manufacture or a computer program product incorporating one or more aspects of the present invention is described with reference to FIG. 6. A computer program product 600 includes, for instance, one or more computer-readable media 610 to store computer readable program code means or logic 620 thereon to provide and facilitate one or more aspects of the present invention. The medium can be an electronic, magnetic, optical, electromagnetic, infrared, or semiconductor system (or apparatus or device) or a propagation medium. Examples of a computer readable medium include a semiconductor or solid state memory, magnetic tape, a removable computer diskette, a random access memory (RAM), a read-only memory (ROM), a rigid magnetic disk and an optical disk. Examples of optical disks include compact disk-read only memory (CD-ROM), compact disk-read/write (CD-R/W) and DVD.

A sequence of program instructions or a logical assembly of one or more interrelated modules defined by one or more computer readable program code means or logic direct the performance of one or more aspects of the present invention.

Although various embodiments are described above, these are only examples.

Moreover, an environment may include an emulator (e.g., software or other emulation mechanisms), in which a particular architecture or subset thereof is emulated. In such an environment, one or more emulation functions of the emulator can implement one or more aspects of the present invention, even though a computer executing the emulator may have a different architecture than the capabilities being emulated. As one example, in emulation mode, the specific instruction or operation being emulated is decoded, and an appropriate emulation function is built to implement the individual instruction or operation.

In an emulation environment, a host computer includes, for instance, a memory to store instructions and data; an instruction fetch unit to fetch instructions from memory and to optionally, provide local buffering for the fetched instruction; an instruction decode unit to receive the fetched instruction and to determine the type of instructions that have been fetched; and an instruction execution unit to execute the instructions. Execution may include loading data into a register from memory; storing data back to memory from a register; or performing some type of arithmetic or logical operation, as determined by the decode unit. In one example, each unit is implemented in software. For instance, the operations being performed by the units are implemented as one or more subroutines within emulator software.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The capabilities of one or more aspects of the present invention can be implemented in software, firmware, hardware, or some combination thereof. At least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered a part of the claimed invention.

Although embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A digital pen user-authentication method comprising:
using a digital data recording pen to write out by a user and capture by the digital data recording pen a handwritten password, the handwritten password comprising at least one handwritten character string to be authenticated;
determining, by the digital data recording pen, whether to authenticate the user based on the handwritten password, the determining by the digital data recording pen comprising:
digitally comparing, by the digital data recording pen, the form and content of the handwritten password to the form and content of at least one handwritten password pre-stored for the user in the digital data recording pen;
authenticating, by the digital data recording pen, the user if the handwritten password of the user is within a defined tolerance of the at least one handwritten password pre-stored for the user in the digital data recording pen; and
if user-authenticated, associating by the digital data recording pen an indication of user-authentication with data of the user produced using the digital data recording pen.

2. The digital pen user-authentication method of claim 1, further comprising pre-storing for each user of at least one user of the digital data recording pen at least one version of a respective handwritten password of the user.

3. The digital pen user-authentication method of claim 2, wherein the pre-storing comprises pre-storing for each user of the at least one user, multiple versions of the respective handwritten password in the digital data recording pen, wherein the pre-storing comprises placing the digital data recording pen in a handwritten password load mode wherein the user stores multiple versions of the respective handwritten password by writing out each version of the handwritten password using the digital data recording pen, the digital data recording pen digitally recording the multiple versions of the respective handwritten password for subsequent digital comparison thereof to a handwritten password of the user to be authenticated.

4. The digital pen user-authentication method of claim 1, wherein the at least one handwritten character string to be authenticated comprises a signature of the user to be authenticated.

5. The digital pen user-authentication method of claim 1, further comprising, if user-authenticated, storing the data of the user in the digital data recording pen, along with the indication of user authentication, and if not user-authenticated, then blocking by the digital data recording pen storing of the data in the digital data recording pen.

6. The digital pen user-authentication method of claim 5, further comprising subsequently transferring stored data of the user from the digital data recording pen, along with the indication of user-authentication therefore.

7. The digital pen user-authentication method of claim 1, further comprising setting by the user the digital data recording pen in an authentication mode to signal to the digital data recording pen that the user is writing out the handwritten password for authentication, and wherein the digitally comparing, the authenticating and the associating occur automatically responsive to the user writing out the handwritten password with the digital data recording pen in authentication mode.

8. The digital pen user-authentication method of claim 1, further comprising providing the digital data recording pen with a digital identification and digital password, and wherein the method further comprises downloading the digital identification and digital password from the digital data recording pen to a system to which the user is to be authenticated, and wherein the associating also comprises providing the indication of user-authentication to the system from the digital data recording pen, thereby providing a multi-level authentication protocol.

9. The digital pen user-authentication method of claim 8, wherein the system comprises a stylus pad, and wherein the method further comprises wirelessly downloading the digital identification and digital password to the stylus pad for system authentication of the digital data recording pen, and subsequent thereto, proceeding with the employing, the digitally comparing and the authenticating of the user via the handwritten password of the user, and if authenticated, allowing by the system the user to proceed with transfer of data to the system using the digital data recording pen.

10. The digital pen user-authentication method of claim 8, wherein the system comprises a stylus pad, and wherein the method further comprises wirelessly downloading the digital identification and digital password to the stylus pad for system authentication of the digital data recording pen, and responsive thereto, if system authenticated, providing via the stylus pad an indication from the system to the user of system authentication, and subsequent to said indication, proceeding with the using, the digitally comparing and the authenticating of the user via the handwritten password of the user, and if user-authenticated by the digital data recording pen, allowing by the system the user to proceed with transfer of data via the digital data recording pen to the system.

11. An apparatus comprising:
a digital data recording pen, the digital data recording pen comprising an authentication component for digitally authenticating a user's handwritten password, the handwritten password comprising at least one handwritten character string to be authenticated, the digital data recording pen responding to the user writing out the handwritten password by:
digitally comparing, by the digital data recording pen, the form and content of the handwritten password to the form and content of at least one handwritten password pre-stored for the user in the digital data recording pen;
authenticating, by the digital data recording pen, the user if the handwritten password of the user is within a defined tolerance of the at least one handwritten password pre-stored for the user in the digital data recording pen; and
if user-authenticated, associating by the digital data recording pen an indication of user-authentication with data of the user produced using the digital data recording pen.

12. The apparatus of claim 11, wherein the digital data recording pen comprises a memory unit for pre-storing for each user of at least one user of the digital data recording pen at least one version of a respective handwritten password for the user.

13. The apparatus of claim 12, wherein the pre-storing includes pre-storing for each user of the at least one user, multiple versions of the respective handwritten password in the digital data recording pen, wherein the pre-storing comprises placing the digital data recording pen in a handwritten password load mode wherein the user stores multiple versions of the respective handwritten password by writing out each version of the handwritten password using the digital data recording pen, the digital data recording pen digitally recording the multiple versions of the respective handwritten password for subsequent digital comparison thereof to a handwritten password of the user to be authenticated.

14. The apparatus of claim 11, wherein the at least one handwritten character string to be authenticated comprises a signature of the user to be authenticated.

15. The apparatus of claim 11, wherein the digital data recording pen further comprises a digital identification and digital password, and when signaled by the user transfers the digital identification and digital password from the digital data recording pen to a system to which the user is to be authenticated, and the associating comprises providing the indication of user-authentication based on the user's handwritten password to the system from the digital data recording pen, thereby providing a multi-level authentication protocol to the system using the digital data recording pen.

16. The apparatus of claim 15, wherein the system comprises a stylus pad, and wherein the user actuates the digital data recording pen to download the digital identification and digital password to the stylus pad for system authentication of the digital data recording pen, and subsequent thereto, the user proceeds via the authentication component with authentication of the user's handwritten password using the digital data recording pen.

17. An article of manufacture comprising:
at least one computer-readable medium having computer-readable program code logic to facilitate user-authentication by a digital data recording pen, the computer-readable program code logic, when executing on a processing unit within the digital data recording pen, performing:
recording, by the digital data recording pen, a handwritten password of a user of the digital data recording pen to be authenticated, the handwritten password comprising at least one handwritten character string to be authenticated;
digitally comparing, by the digital data recording pen, the form and content of the handwritten password to the form and content of at least one handwritten password pre-stored for the user in the digital data recording pen;
authenticating, by the digital data recording pen, the user if the handwritten password of the user is within a defined tolerance of the at least one handwritten password pre-stored for the user in the digital data recording pen; and
if user-authenticated, associating by the digital data recording pen an indication of user-authentication with data of the user produced using the digital data recording pen.

18. The article of manufacture of claim 17, wherein the computer-readable program code logic, when executing on the processing unit, further performs pre-storing for each user of at least one user of the digital data recording pen at least one version of a respective handwritten password of the user.

19. The article of manufacture of claim 18, wherein the at least one handwritten character string to be authenticated comprises a signature of the user to be authenticated.

20. The article of manufacture of claim 17, further comprising providing the digital data recording pen with a digital identification and digital password, and wherein the computer-readable program code logic when executing on the processing unit within the digital data recording pen, downloads the digital identification and digital password from the digital data recording pen to a system to which the user is to be authenticated, and wherein the associating also comprises providing the indication of user authentication to the system from the digital data recording pen, thereby providing a multi-level authentication protocol.
